(19) United States
(12) Patent Application Publication
(10) Pub. No.: US 2003/0023583 A1
(43) Pub. Date: Jan. 30, 2003

(54) Presearch engine

(76) Inventor: Paul Mokonya Eko, Hudson, OH (US)

Correspondence Address: PAUL M. EKO, 7561 PEARL ROAD, CLEVELAND, OH, 44130, US

(21) Appl. No.: 09/962,264

(22) Filed: Sep. 26, 2001

Related U.S. Application Data
(60) Provisional application No. 60/235,568, filed on Sep. 27, 2000.

(51) Int. Cl. G06F 7/00

(52) U.S. Cl. 707/3

(57) ABSTRACT

A method and means of searching a pre-defined database of files, records, and folders for a specific sought after element of interest. This search consists of a set of relatedly categorized mouse-over tree menu that breaks down to specific branches of columns and rows of items being searched by moving the mouse over the trunk, branch, and fruit in a tree-like family of database hierarchy. The trunk is the main listing of the item being searched; the branch is a group or category of the main trunk item; and the fruit is the result of searched items listed at the end of the family tree menu. Fruit items are clickable into websites or other databases so named. Mouse-over means cascade or cascading. In this case, cascading in rows and columns to generate other rows and images, etc.

The invention pertains generally and particularly to a predetermined method and apparatus for searching files, records, and folders in a database and or (on the internet). Specifically, the apparatus is a presearch engine in which all the items to be searched have already been researched, identified, categorized, compiled, programmed, and displayed in a unique method for easy access to the user.

### BACKGROUND OF THE INVENTION

The World Wide Web or Internet, as it is called, is a double-edged sword for most users. On the one hand, it has a lot of desired information that most users seek; on the other hand, it is cluttered with debris of undesirable proprietary mumbo jumbo of tartered information that makes it very frustrating for the faint-hearted user to engage in.

The World Wide Web attracted close to 155 million users in 1999 and is expected to grow even further at a rate of 20% a year. Most internet users surf the Web for the following reasons:

a) Get information (self-help knowledge or therapy, research, projects, etc)

b) Chat (chat rooms)

c) Communicate (email or internet phone)

d) Shop (virtual malls and individual websites)

e) Real Time Tracking (news, sports, weather, parking offices, etc.)

f) Speech Forum (politics, organizations, PR interests, gov., etcl.)

g) Entertainment (adult sites, movie previews, MP3, games, etc)

h) Etc.

Granted that the Internet attracts that many users, it is very flawed in 6 aspects: navigation, clutter, prozac laced search engines, pornography, content, and privacy.

1) NAVIGATION: It is too time consuming to find anything of relevance on the internet. It is estimated that there are 4 million websites in operation today and the DNS acquisition rate stands at 31% growth per annum. This means that the internet is going to be very difficult to navigate in the future because of the mere size of the platform. Besides, software incompatibility does not help innocent users who expect all these proprietary products and services to smoothly navigate without a hitch. Search engines have helped in the navigation crisis but they have not done enough especially in today's age of trying to be “everything to everybody”.

2) CLUTTER: There are too many distractions in the form of unwanted ads that permeate and invade a user's protected sense of cyber space which does not match reality. It is unimaginable what one runs into when one opens a website link enroute to a desired sight. As more and more websites have gained traffic, they have realized that such traffic (called “hits”) is marketable. And, with the entry of mortar name brand companies into the web with a bang, there is a need by cash-strapped internet companies for survival . . . cash. And, cash is raised by selling more and more advertisement. This sometimes means the user has to spend hours upon hours filling out forms that do not benefit the user in order to get “free internet access” or a “free computer” just to be bugged down with clutter when the user logs unto the specific website the user signed up for . . . frustrated.

3) PROZAC-LACED SEARCH ENGINES: Most search engines have the right intention to help the clutter and navigation problems but they have a terrible delivery format. A user has to click two, three, four, or five times to find something of interest . . . just to be reminded that there are 1,999,999 more such requests to view if desired. Some users think they are stupid or are made stupid by the internet and have no desire to exert their will to go online because the search engines frustrate the search effort. A search of the word “copyright” using most search engines would lead a user to 26 hits related to “Australian Copyright Laws”. Most of these listings “Aussie hits” are triplicates. How about US copyright laws? We're in America and want American laws. Of course, most search engine are so cluttered with information that they make themselves difficult to navigate let alone help the user find anything. For, a lot of search engines want to become portals (first preference page user opens up to when user goes on the internet). Unfortunately, search engines are trying to become everything to everybody . . . news, sports, search feature, chat, isp, etc. One user thought the so called search engines were riding on prozac because they are too cumbersome and intimidating to use.

4) PORNOGRAPHY: (No comments but We'll try) Parents who want their minor kids to be up to date with today's technology in order to avoid the digital divide crisis put their kids online at their own risk. The sad part about parenting and the internet is that it is not so much the kids wanting to log unto pornographic sights that annoys parents as much as the mere journey to innocently navigate the web and do some homework or research project and to be “stunned” by the pornographic ads on the way. These pornographic ads are “unexpected, provocative, intrusive, unfair, and improper” to minors. Pornographers have a right to their websites. Nobody is going to try and ban them from the internet; however, probability that a minor will run into a sexually explicit pornographic ad on the minor's way to a project site is 72%. Of course, one should not forget Bob whose six year old granddaughter dashed to her computer to go get her grandfather a doll from Ebay. We should not take a guess what kind of dolls they found under the headings of ‘dolls”, should we?

5) CONTENT: The quality of editorial content on the internet is very shaky especially if coming from start-ups that do not have pockets to properly sure themselves with a stable editorial staff. As a result, part of the search clutter and navigation problems are because users experiment with “dressed up names” for companies and services just to be disappointed in promised products, services, and content . . . that were searched by current search engines.

A lot of search engines do have editorial staff that browse and search through the web to find quality websites to direct their users to. But, at the rate the web is growing, such editorial searches and HTML header searches are not going to keep up with the times. Content on the internet is improving but it needs to be simplified even better.

6) PRIVACY: A lot of users are wrongly convinced that the internet is not a safe place for their credit cards or personal information (perception). The internet is a safe place for users but online infrastructures have to facilitate the means of accessing and manipulating data on the internet in order to gain the trust, confidence, and “laissez-faire” attitude of the user. We know that a lot of internet companies are profiling their users with the use of “cookies”. There are good cookies (speed up ordering process) and there are bad cookies (selling users' names and info to other entities). The worry about “privacy” on the internet by users is a little bit far fetched considering that most users who have credit cards will gladly hand it over to a mortar merchant without even worrying a bit about privacy. A credit card is safer online than through a mortar store. But, the internet privacy paranoia is not helped by clutter, poor content, 1,999,999 more sites waiting, and the abject consumer cry that the internet is “a messy prostitute you keep going back to” . . . and don't know why you have this bad addiction.

Glossary of Invention Tree

MODT=Trunk

MODB=Branch

MODF=Fruit

MODI=ICON

MODR=ROWS

MODC=COLUMN

MODS=SEARCH

MODA=reserved

MODB=BRANCH

MODC=COLUMN

MODD=reserved

MODE=reserved

MODF=FRUIT

MODG=reserved

MODH=reserved

MODI=INDICATOR

MODJ=reserved

MODK=reserved

MODL=reserved

MODM=reserved

MODN=CLICKEND NUMBERS

MODO=reserved

MODP=reserved

MODQ=reserved

MODR=ROW

MODS=SEARCH

MODT=TRUNK

MODU=reserved

MODV=reserved

MODW=reserved

MODX=reserved

MODY=reserved

MODZ=reserved

### SUMMARY OF INVENTION

The current invention is called a presearch engine. It is a method and means of searching a predefined database of files, records, and folders for a specific element of interest on the internet or world wide web. The presearch consists of a set of related and categorized items that display columns and rows when a mouse is put over each of these related groups of items through a mouse movement on the item in a move called mouseover.

Apparatus categorizes items into three main groups in a tree family: trunk, branch, and fruit:

Trunk: The trunk of the tree is the main item in the framework that is originally being searched by the user. Example of a trunk item is AUTOMOBILE.

Branch The branch is a set of related subgroups of the trunk arranged in columns and rows. These are generated by placing the mouse over a trunk item. An example of a branch item in an AUTOMOBILE trunk is DEALER or MANUFACTURER.

Fruit The fruit is a subdivision of the branch and is generated by placing the mouse over a column-row item. In the case of an AUTOMOBILE trunk that is popped by a branch of MANUFACTURER, possible is GENERAL MOTORS. The following are unique characteristics of the fruit:

you can click it . . . end of family tree line. A reward for searching

has “no right arrows” for further investigation like a branch fruit item

is numbered in its specific category in ascending numbers

fruit has a specific name: person, company, group, agency, entity, etc.

is linked to a website through a URL or a dot.com.

The maneuverability of items in the device is controlled by scrollbars in the trunk, branch, and fruit. In the trunk, the scrollbar is always present and ready to be moved up or down . . . depending on the alphabetical position of the item being searched. The scrollbars in the branch and fruit are not readily available until a mousover on a trunk or branch item triggers a list of items that is longer or wider than the predefined framework of the invention. Incidentally, the trunk has a uniquely cued shortcut to reaching items faster than scrolling using the scrollbar to the right.; this shortcut is a clickable index of letters on top of the trunk and identically at the bottom of the trunk. The index reads as follows: (A-E) (F-K) (L-P) (Q-V) (W-Z). Clicking any of these indexed categories in the trunk will display trunk items in that letter group.

The invention specifically is a presearch of intenert related items but premium content files are also within the prisms of the invention. The presearch concept is uniquely exemplary of the fair use of existing public domain fragmented technologies in the scripting of a leading edge technologic that has been compiled for premium use on and offline. These technologies include but are not limited to the following public domain tools: tree menu, onmouseover, pop up screens, html, java, javascript, cgi, ,,, alll programming languages, etc. . . . list all tools, etc. so that you can not be exempted.

At any given time, the exact number of sites (fruits) can be determined as follows: Total population equals the sum of Ta thru Tz where Ta is trunk item A and Tz is trunk item Z. Individual items of trunk items can be calculated as follows:

Ta=(Aa thru Az)+(Ba thru Bz)+ . . . (Za thru Zz)

where Aa is the first branch column-row “a” and Az is branch item row z; Ba is the second row at column 1 and Bz is the z item in row B and Z is the last branch row that triggers a fruit item.

This invention was designed knowing that the internet and present search engines are flawed. The user will reap the following benefits from this invention:

it is fast . . . it flies

user is not overwhelmed by unwarranted and unrelated search items

content can be targeted to specific users without offending others . . . eg. pornography on children

there is no advertisement on this invention

there is no place for cookies in this invention

invention is upgraded weekly

sorry, website shuts down every Friday for “lazy Fridays” celebration

The invention allows for URLs or dot.coms to be added or removed by the provider at convenience without restrictions as to quantity or categories.

ONLINE, OFFLINE, and COMBO SCHEMES

This invention is very dynamics in its foresight and capabilities. It can be used offline with any operating system that envisions its tangents for specific data manipulation and can also be used online through a network such as the internet. Last but not least is the ability to manipulate the invention so that a combo usage of “on” and “offline” is programmable.

Offline Spectrum

“Offline” is defined as follows:

stand alone computer

local area network (LAN) computers that are not interactive

far away devices on communication networks that are off the interactive loop from one another . . . off the hook

device that is outside of a predefined loop of interactive data exchange etc.

Invention works in an offline computer environment by loading the invention into a device in that offline spectra. The offline platform usually present for invention to work is called an operating system within or without the device. Thus, the invention (presearch engine) will not work by itself on its own merit unless it is imbedded with operating system functions to elaborately stretch the presearch engine functions.

Notable operating systems invention works in include (but not limited to) the following:

windows

linux

dos

novell

apple operating system

others

others

others

others

others

others

others

other

Etc.

If apparatus is installed in a stand alone system, usually the FRUIT in the tree family will have to be modified since the FRUIT in this invention contains URLs or dot.coms which are address specific in a network especially on the internet. In the case of offline FRUITS in a stand alone environment, the URLs and dotcoms are hereby defined as specific addresses in an “intended location” such as an address, page, file, folder, or other predefined location within or without the device. If within the device then stand alone has capability of accessing and manipulating its data comprehensively. A comprehensive case may be a stand alone computer that has a large enough hard drive that can handle an elaborate database using the presearch engine apparatus for convenience in the database design. If without the device, then system may need an add-on apparatus such as a mobile storage unit to help to manipulate data. Such units may take the form of an external zip drive, tape drive, floppy disk drive, etc.

A stand alone device could utilize this invention on its inventory management system whereby specific inventory pricing are categorized in columns and rows and a click on the FRUIT will yield the detailed specifications about that particular item being researched.

LAN offline usage means a device is hooked or linked to another device but is not in contact with that device at the point of impact with a presearch engine. This kind of offline can be intentional or unintentional in nature but the impact factor with the presearch engine is the same. Some offlines may be necessary for economies of scale especially when network line charges in the form of real time necessitate an “off the hook” economy for maintenance or to save money until crucial need arises for a “log on” to be made and thus convert into an online scheme.

FAR AWAY NETWORK (FAN) devices that are networked but are not interactive with one another have similar characteristics to LAN when impacted to by a presearch engine . . . with a few exceptions: FANS usually have “interceptors” in the form of third party devices or bodies that perform the following (but are not limited to these only) functions to data:

compress and decompress

encode and decode

filter

massage

stream

bounce

download

Etc.

The apparatus format will always be the same but could be tainted in the form of bugs due to version and programming conflict when offline or online. The invention's concept will not change due to the manipulative functions performed on FANS or LANS.

Online Spectrum

ONLINE means a device is linked to another device for the review and/or exchange of data. The apparatus is specifically designed for the internet (WWW) but it is not restricted to internet use only. FANS and LANS can use a presearch engine to manipulate data so long as each device has the proper version of the operating system requirement protocols to run . . . and the apparatus is installed in the device:

“To install” means but is not restricted to:

to access

to connect

to open to and or from

to link to and or from

to download

Etc

With a direct online install, each TRUNK item search is fetched by the system on request and put in a temporary pouch or cache in the user's local device or computer. S

Once the user has installed the apparatus, the browser functions of apparatus will kick in and display the apparatus on the screen. Claims 1 thru claim 33 will ensure. Without a browser, on the internet, apparatus will not function Apparatus works better when the latest browser version of Internet Explorer, Netscape, or equivalent browser is used. And, the video mode recommended is 1024 by 768 although apparatus will work with other graphic modes

Combo Scheme

This is a format where the apparatus works using the combination of online and offline. The program is written such that if a user has an offline installation of device in user's computer, and user logs online by a direct internet connect, the program will adjust itself to first go to the local offline for the database (to speed up search or find) before logging to the internet. Such, it is recommended that user download apparatus in their hard drive because it will speed up find

### BRIEF DESCRIPTION OF THE DRAWINGS

FIG. 1 (Page 1) is a framework of the invention showing the following main compartments:

Machette.com. . . . the title page name with a “tm” notice

Trunk

Branch

Fruit

Bottom Scrollbar underneath serving Branch and Fruit

Side Scrollbar to the right of the entire framework

Copyright notice comprising of 3 requirements:

copyright logo or notice

year of copyright

copyright assignee/owner

“Patent Pending” notice with a “powered by Presearch Engine” notice

FIG. 2 (Page 2) is the detailed framework makeup of the TRUNK including the following:

Alphabetical shortcut index scrollbar on top

Alphabetical shortcut Index scrollbar at the bottom (Identical to top)

Manual trunk scrollbar to right of TRUNK items

top arrow mini scrollbar

middle block scrollbar

bottom arrow mini scrollbar

FIG. 3 (Page 3) is the detailed framework makeup of the BRANCH including the following:

Manual branch scrollbar to right of BRANCH items

Top arrow mini scrollbar

Middle block scrollbar

Bottom arrow mini scrollbar

Manual branch scroller at the bottom of BRANCH items

top arrow mini scrollbar

middle block scrollbar

bottom arrow mini scrollbar

FIG. 4 (Page 4) is the detailed framework makeup of the FRUIT including the following:

Manual trunk scrollbar to right of FRUIT items

top arrow mini scrollbar

middle block scrollbar

bottom arrow mini scrollbar

FIG. 5 (Page 5) is the TRUNK image with TRUNK items listed alphabetically and ready to be “moused” for a MODCROWS initiation process. Our example today is ADDICTIONS

FIG. 6 (Page 6) is the BRANCH image triggered by putting the mouse over a trunk item. In this case, we are dealing with “addictions:. The following are notable in the BRANCH:

investigate more arrow

branch items popped by ADDICTIONS:

Drug

Gambling

Internet

Recovery

Sexual

Smoking

Workaholic

FIG. 7. (Page 7) is the FRUIT image triggered by putting the mouse over a BRANCH search category.

In the Fruit section, the following items are noticeable:

items are numerically numbered

user can click item with “mouse hand”

items have a specific name, title, etc.

this is the end of the tree family . . . fruit

there are no right arrows indicating investigate more

there is a URS or dot.com underneath each FRUIT item

In this case, our sample is WORKAHOLICS

Workaholics International Network

Workaholics Anonymous

Workaholics info

Home of the Workaholics

Workaholics Dreamworks

Workaholics Information

Workaholic Woes

Dale Carnegie Training

Workaholics in a Family Business

UMHS—Workaholics

FIG. 8 (Page 8) is the composite diagram of the invention's framework as seen by the user.

FIG. 9 (Page 9) is a flowchart of our example ADDICTIONS. This is the possible path that the user takes when making a search.

ONLINE or OFFLINE

The invention can be run online or offline. When run online, it is slower than when run offline. Users are encouraged to download the offline version into their hard drive and run from there. For, the program is written such that it first goes to the offline version before it goes through the online path.

FIG. 10 (Page 10) is the schematic flowchart of the database access used by this invention on demand online.

FIG. 11 (Page 11) is the schematic for running the invention offline from the hard drive, floppy, cdrom or other offline media. From the hard drive, the program has to be downloaded from the internet into the user's hard drive. Or the program can be accessed through a CD. And, it will run fast

### INVENTION EQUIVALENCE

This invention, especially the mouse over display column rows (MODCROWS), does not exist any where especially on the internet or related databases. Granted that onmouseover functions are available on the internet for a pop up screen here or there, nobody has been able to seriously chain them together with spicificity the way our MODCROWS technology does.

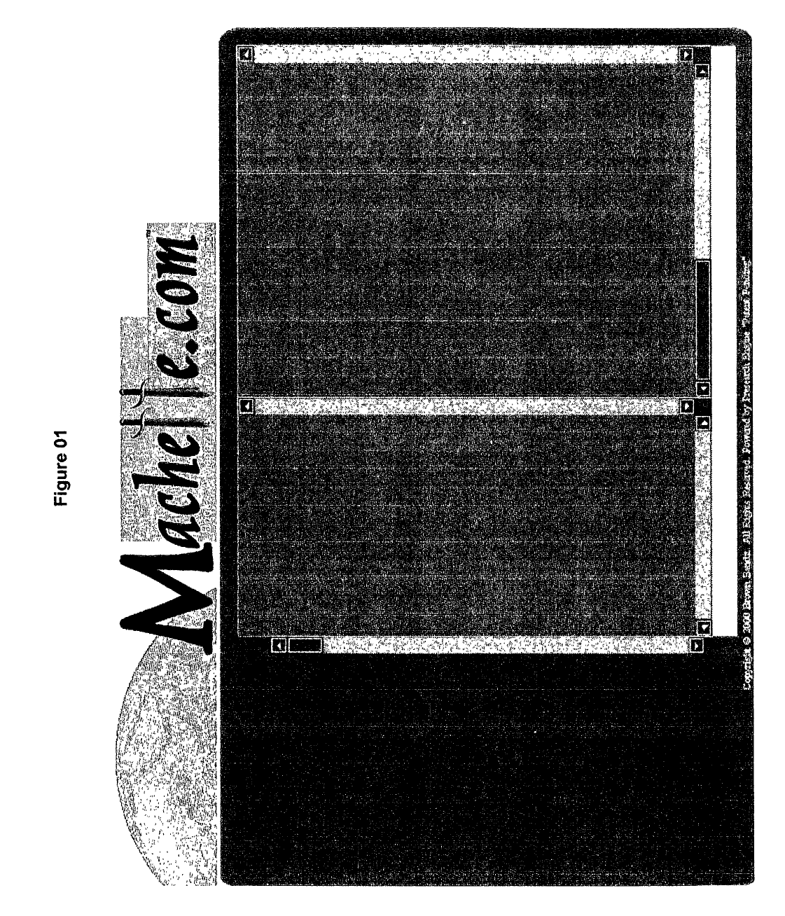

FIG. 1 (page 1) is a framework of the invention showing the main compartments, not labeled.

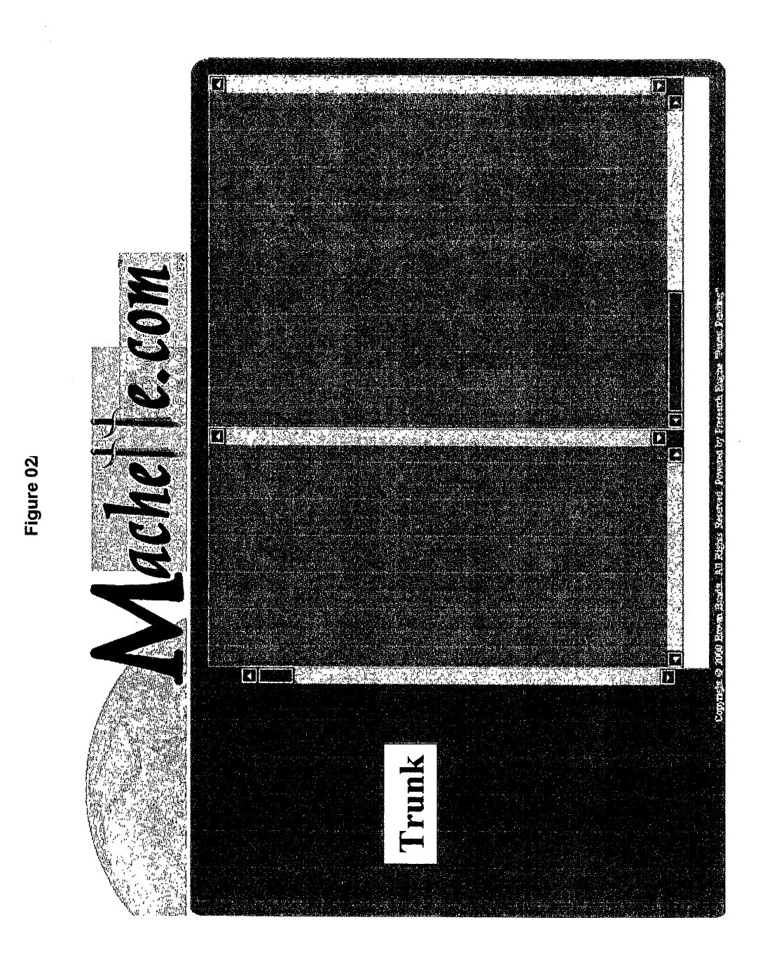

FIG. 2 (page 2) is the framework of the invention identifying one of the main compartments, the TRUNK.

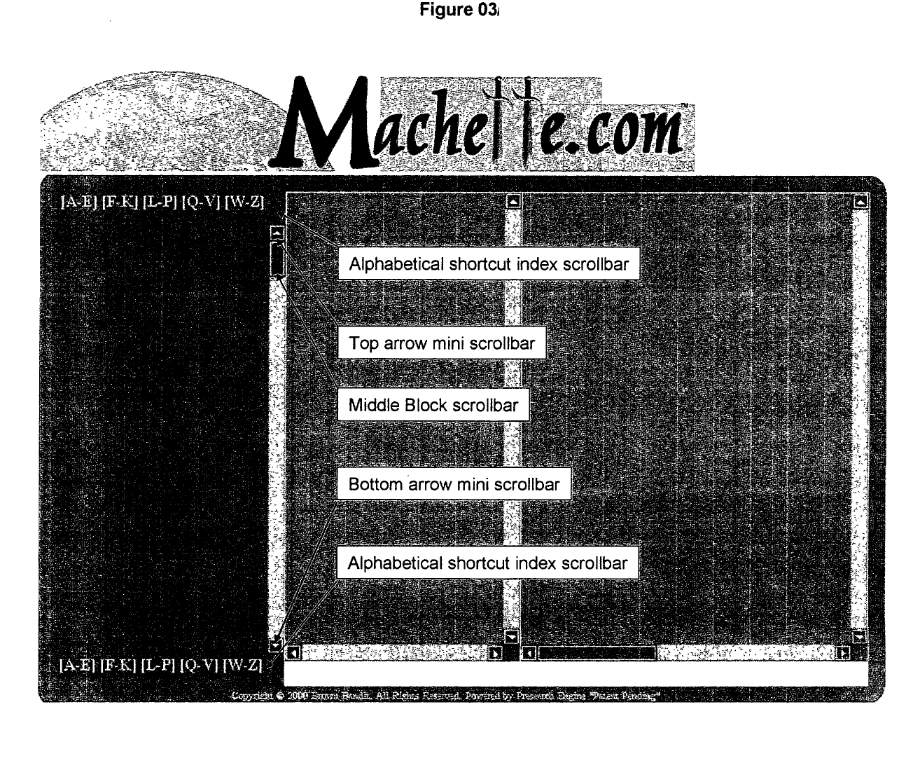

FIG. 3 (page 3) is the detailed framework makeup of the TRUNK including the following:

a) Alphabetical shortcut index scrollbar on top

b) Alphabetical shortcut index scrollbar at the bottom

c) Manual trunk scrollbar to the right of TRUNK items

Top arrow mini scrollbar

Middle block scrollbar

Bottom arrow mini scrollbar

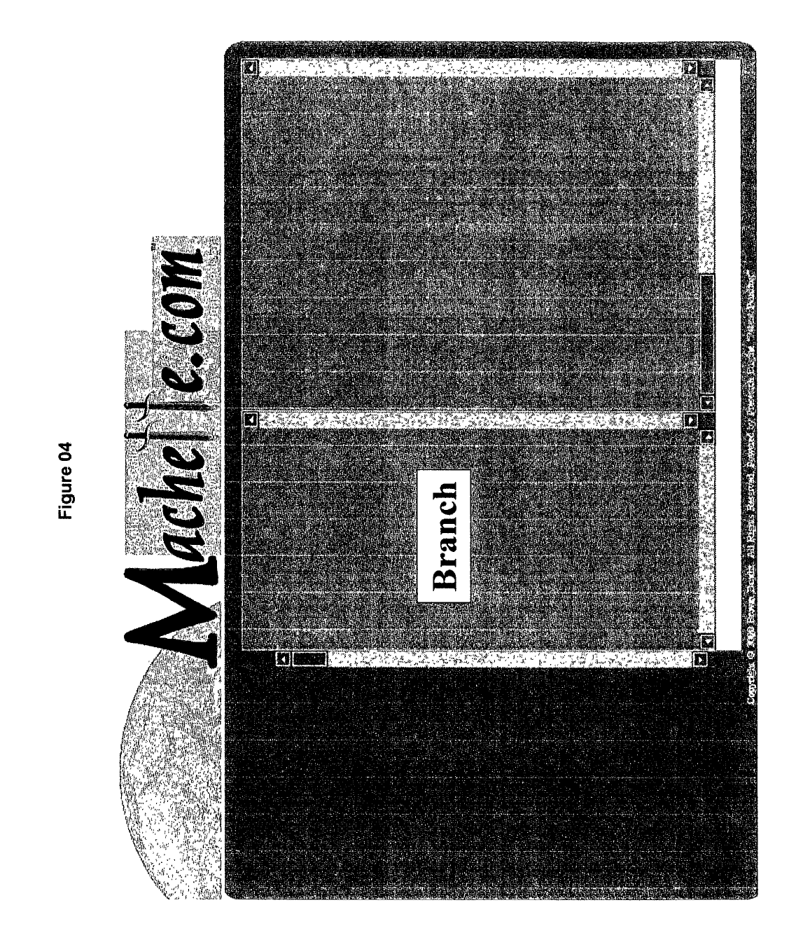

FIG. 4 (page 4) is the framework of the invention identifying one of the main compartments, the BRANCH.

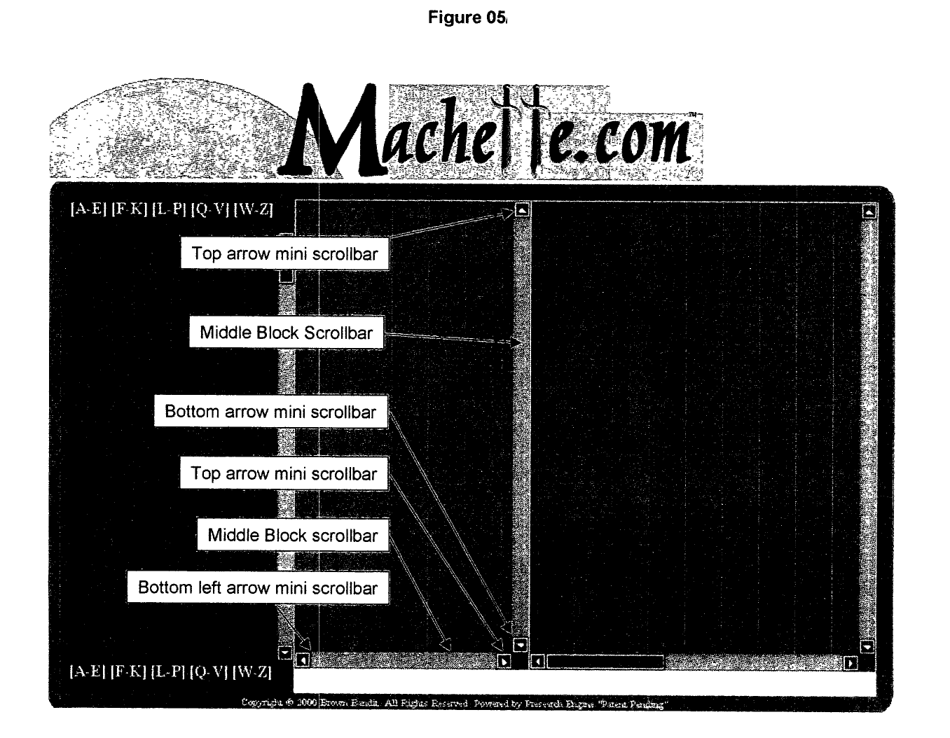

FIG. 5 (page 5) is the detailed framework makeup of the BRANCH including the following:

a) Manual branch scrollbar to the right of BRANCH items

Top arrow mini scrollbar

Middle block scrollbar

Bottom arrow mini scrollbar

b) Manual branch scrollbar to the bottom of BRANCH items

Bottom left arrow mini scrollbar

Bottom middle block scrollbar

Bottom right arrow mini scrollbar

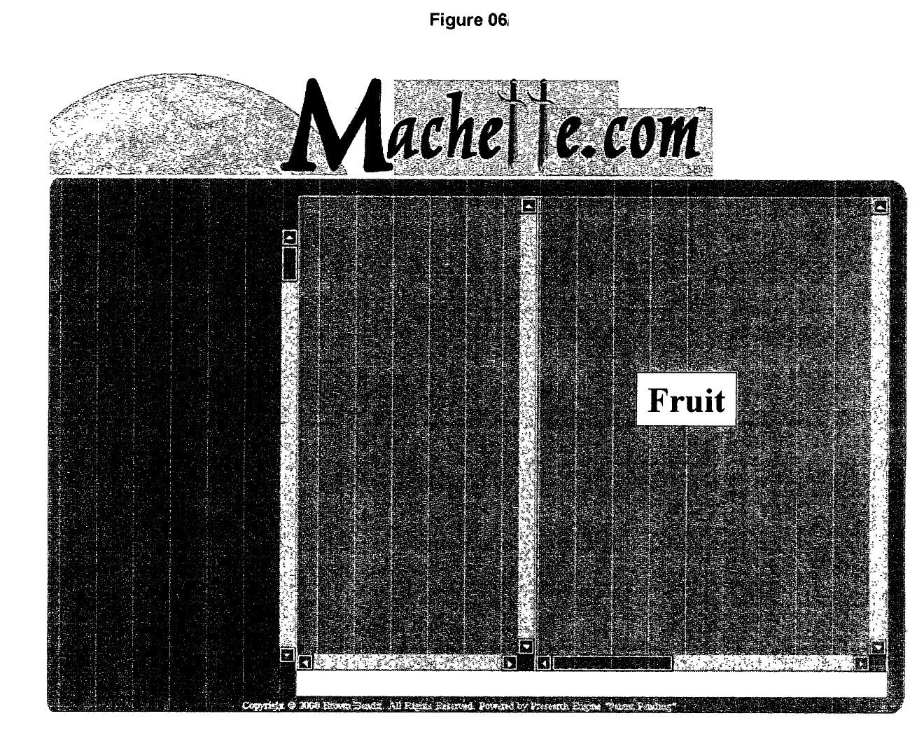

FIG. 6 (page 6) is the framework of the invention identifying one of the main compartments, the FRUIT.

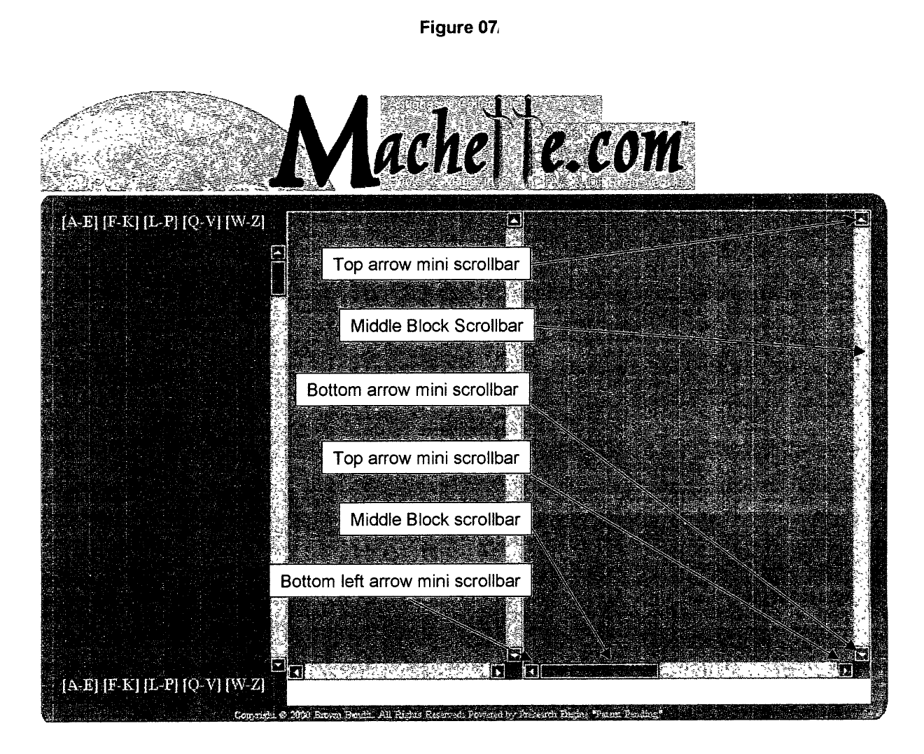

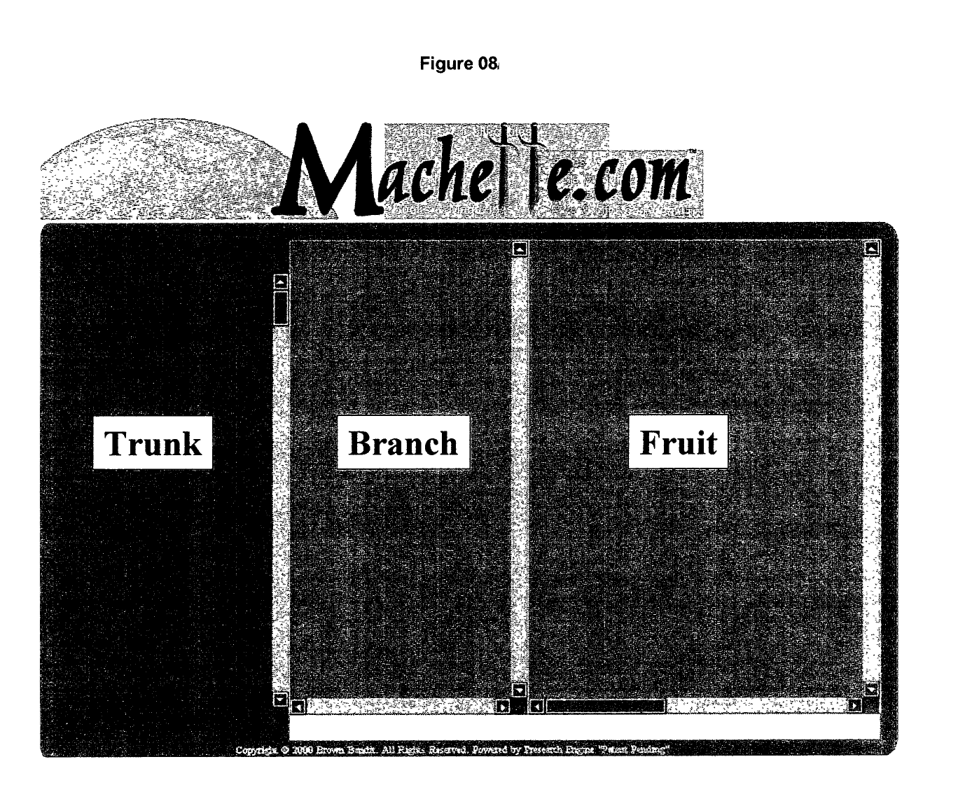

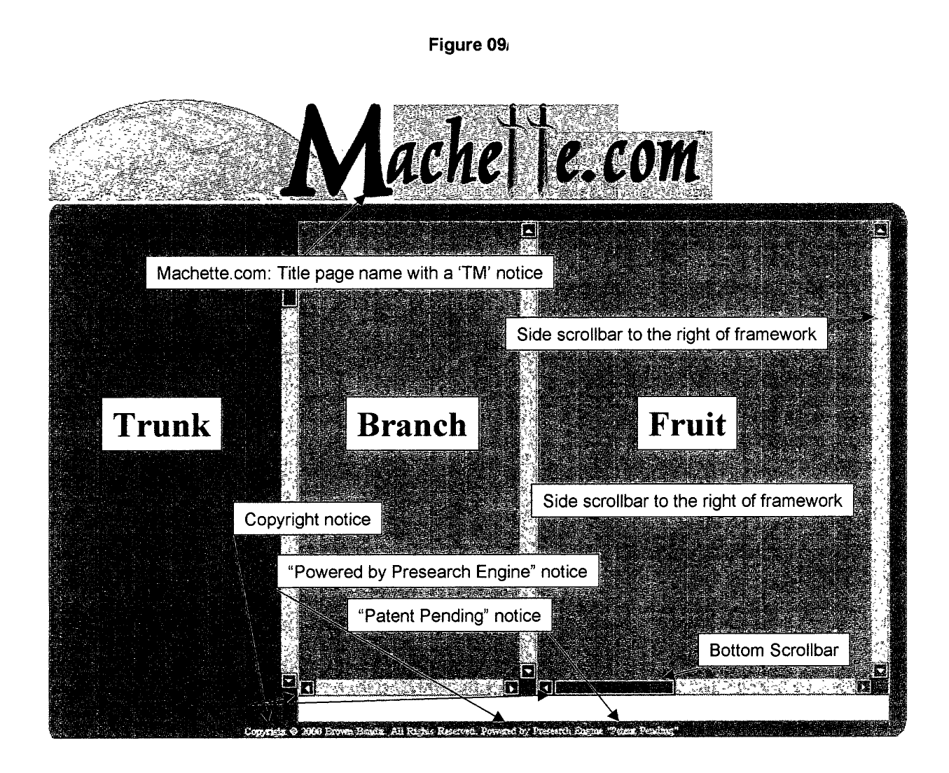

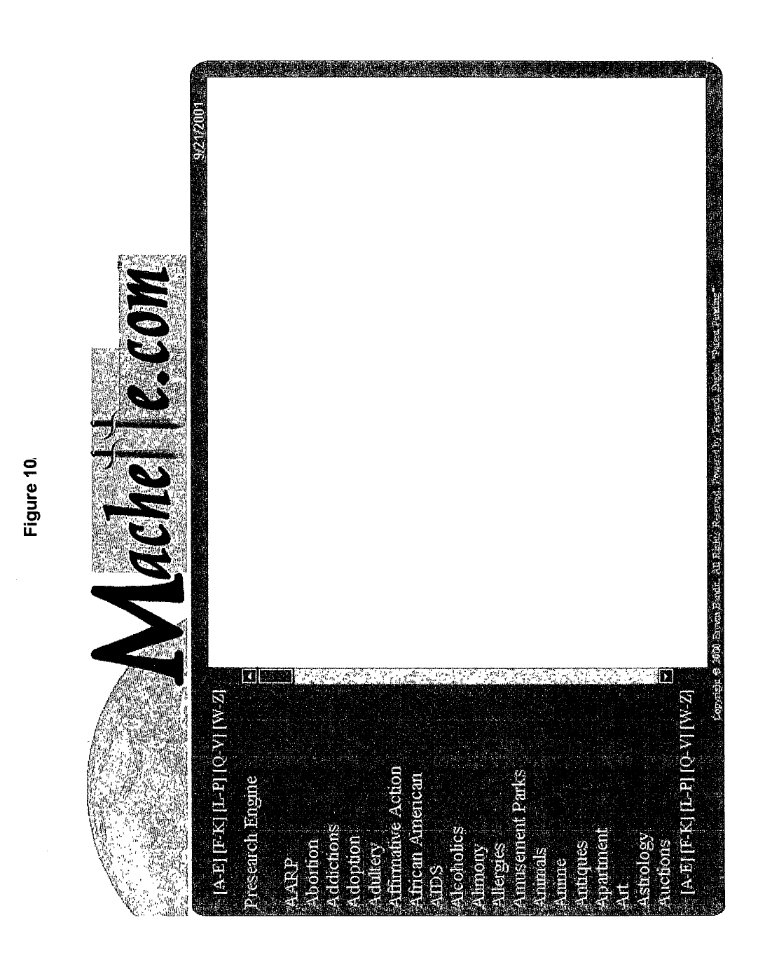

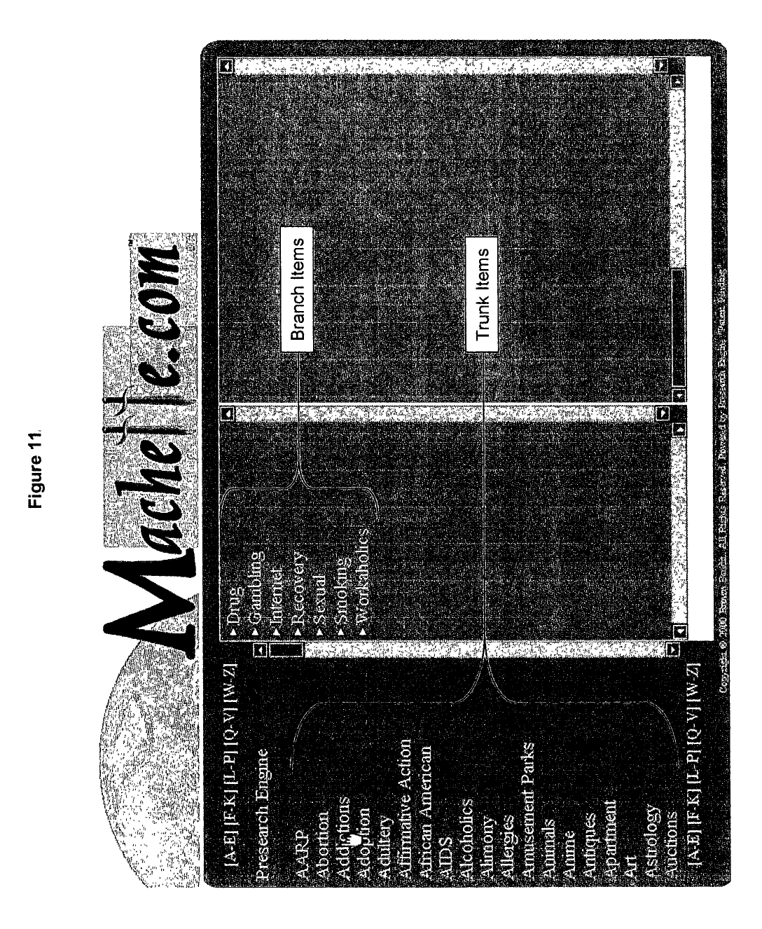

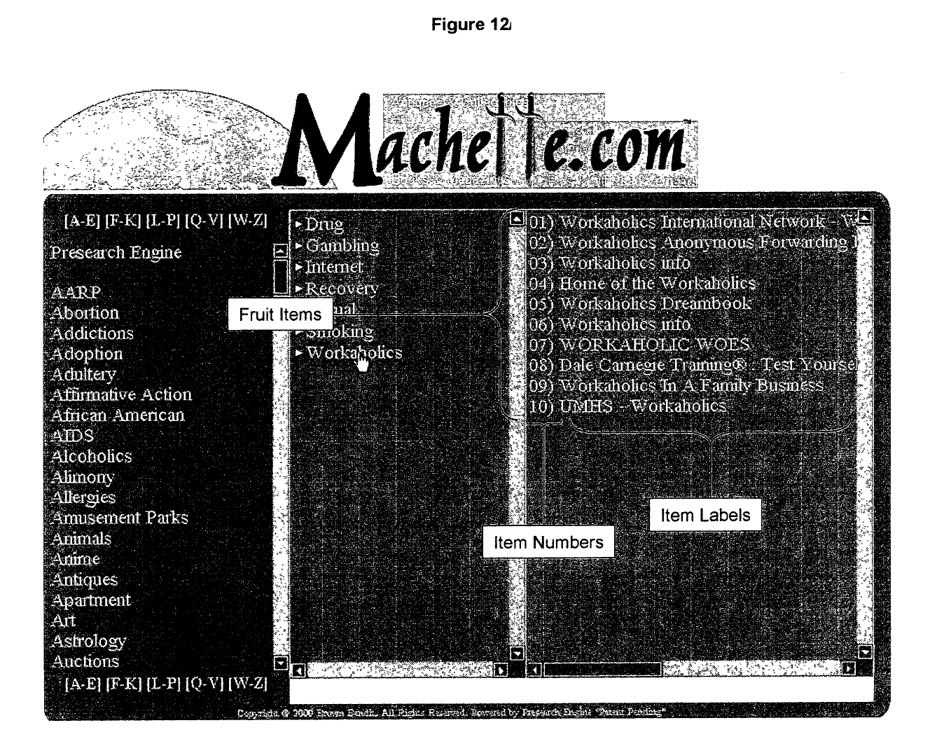

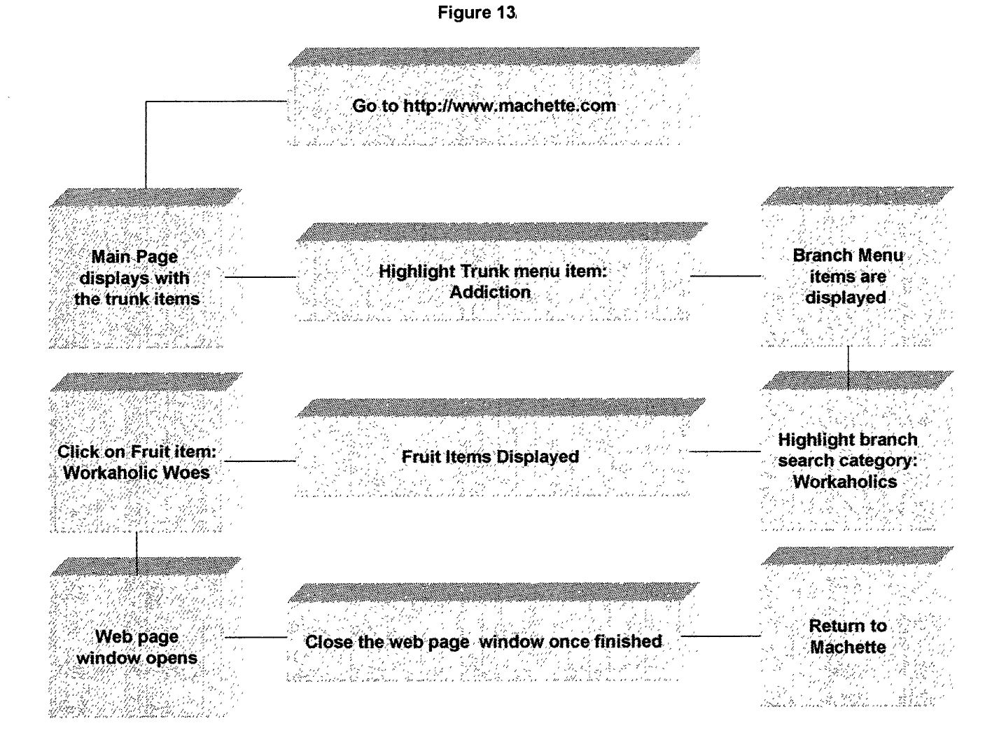

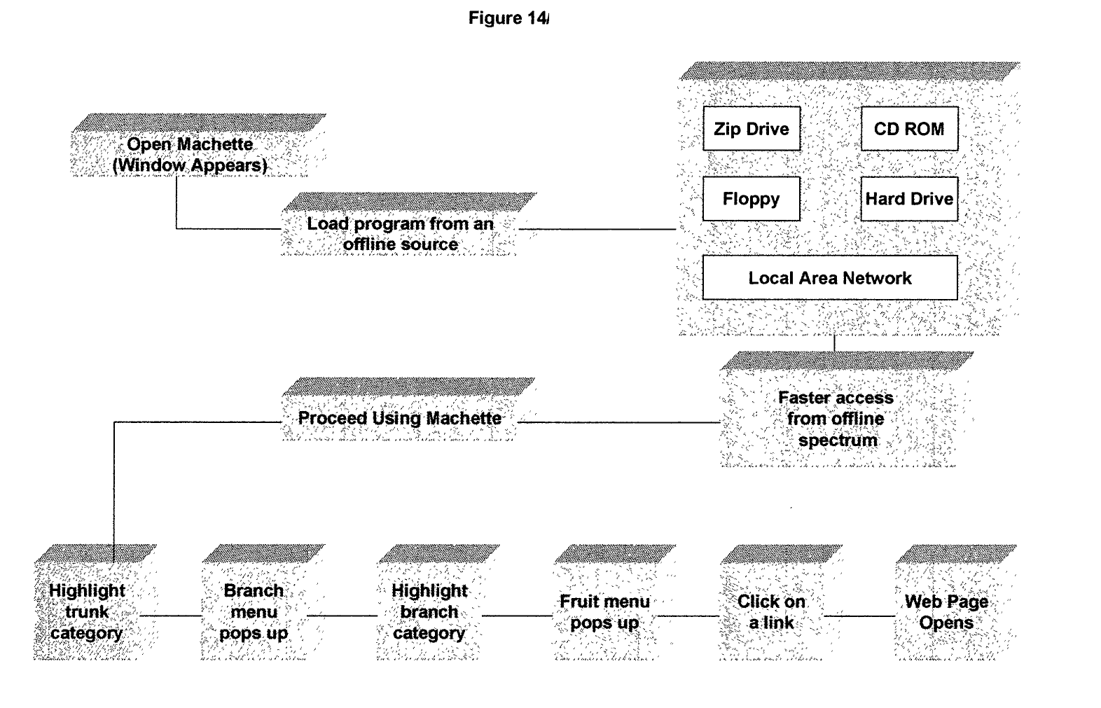

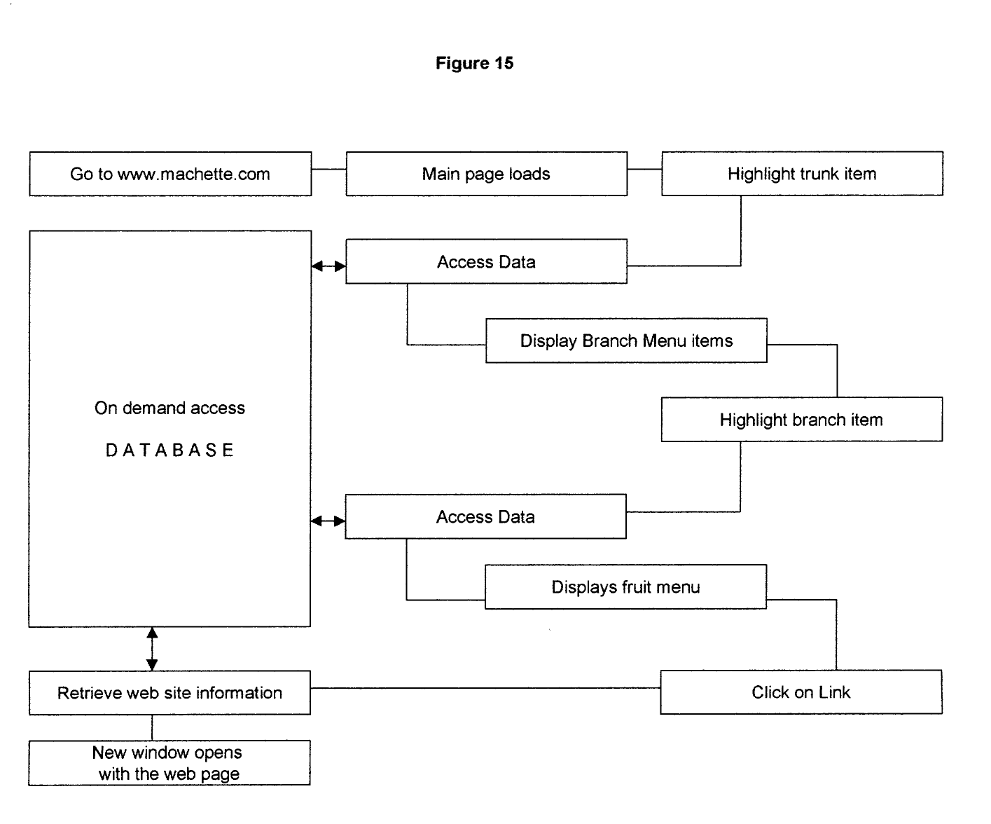

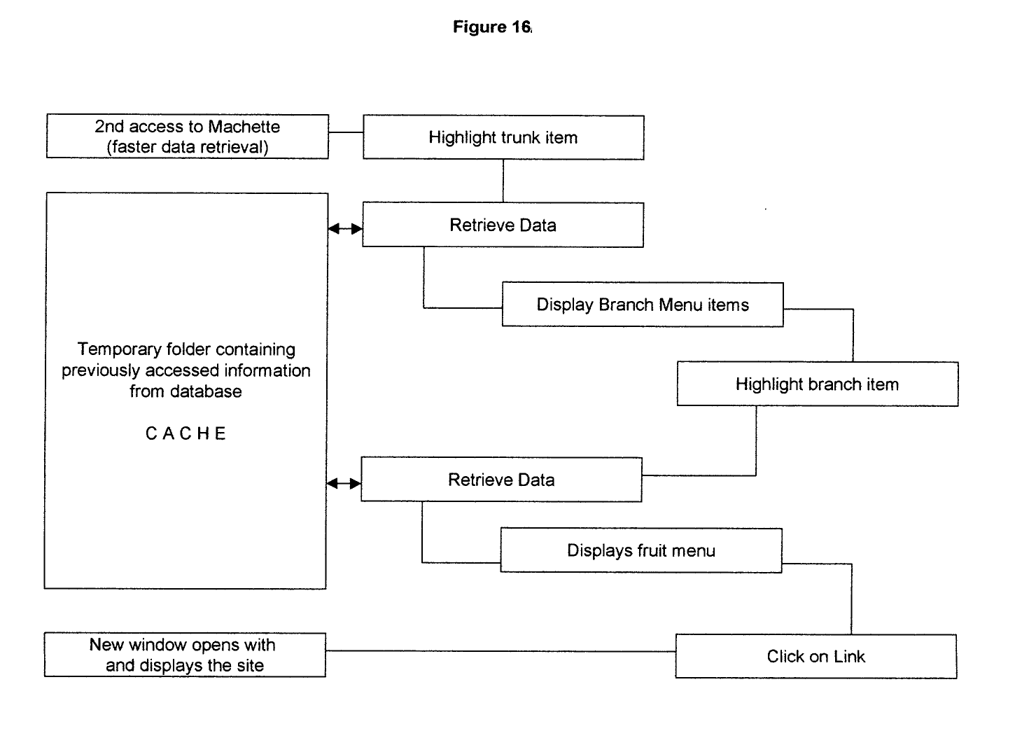

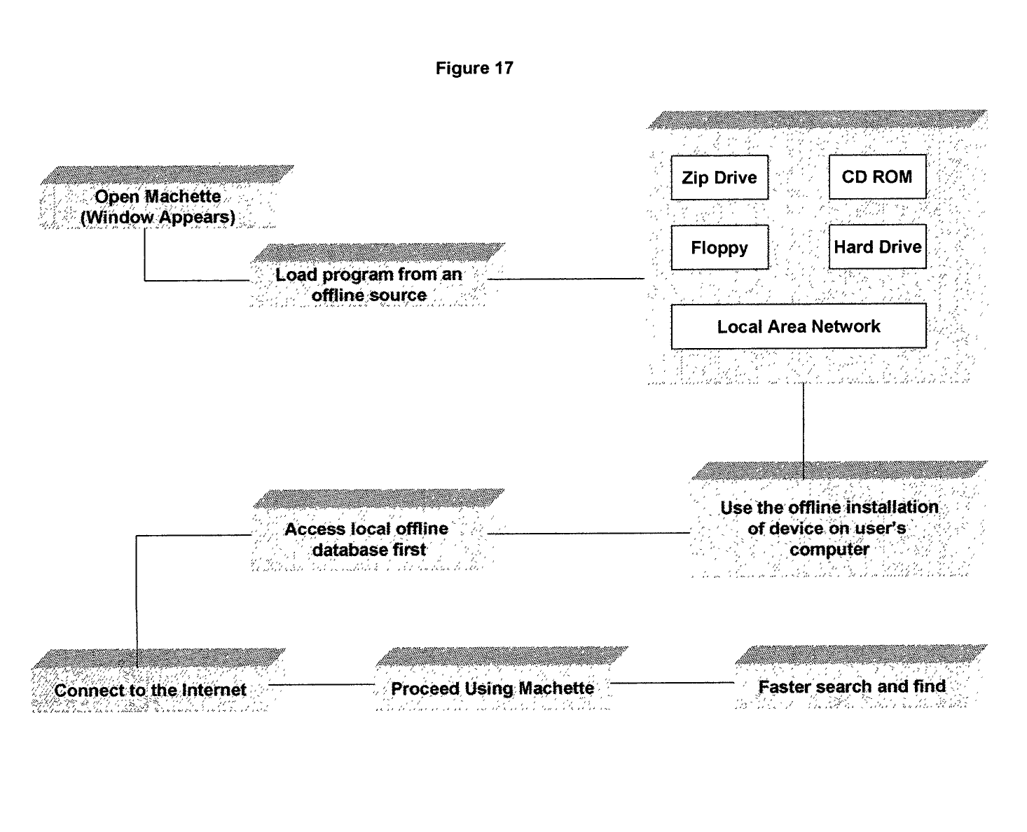

FIG. 7 (page 7) is the detailed framework makeup of the FRUIT including the following:

a) Manual fruit scrollbar to the right of FRUIT items

Top arrow mini scrollbar

Middle block scrollbar

Bottom arrow mini scrollbar

b) Manual fruit scrollbar to the bottom of the FRUIT items

Bottom left arrow mini scrollbar

Bottom middle block scrollbar

Bottom right arrow mini scrollbar

FIG. 8 (page 8) is the framework of the invention identifying all of the main compartments, the TRUNK, BRANCH, and FRUIT.

FIG. 9 (page 9) is the framework of the invention showing the main page details including the following::

a) Machette.com. . . . the title page name with a “tm” notice

b) Trunk

c) Branch

d) Fruit

e) Bottom scrollbar underneath serving BRANCH and FRUIT

f) Side scrollbar to the right of the entire framework

g) Copyright notice comprising of 3 requirements:

Copyright logo or notice

Year of copyright

Copyright assignee/owner

h) “Patent Pending” notice w/a “powered by Presearch Engine” notice

FIG. 10 (page 10) is the composite diagram of the invention's framework as seen by the user.

FIG. 11 (page 11) is an example of the mouseover process:

a) The TRUNK items are listed alphabetically and are ready to be “moused” for a MODCROWS initiation process. Our example today is ADDICTIONS.

b) The BRANCH image is also displayed in this figure, which was triggered by putting the mouse over a trunk item. In this case, we are dealing with “Addictions”. The following are notable in the BRANCH:

1) Investigate more arrow

2) Branch items popped by ADDICTIONS:

Drug

Gambling

Internet

Recovery

Sexual

Smoking

Workaholic

FIG. 12 (page 12) is the FRUIT image triggered by putting the mouse over a BRANCH search category.

In the FRUIT section, the following items are noticeable:

a) Items are numerically numbered

b) User can click item with “mouse hand”

c) Items have a specific name, title, etc.

d) This is the end of the tree family . . . fruit

e) There are no right arrows indicating investigate more

f) There is a URS or dot.com underneath each FRUIT item

g) In this case, our sample is WORKAHOLICS

1) Workaholics International Network

2) Workaholics Anonymous

3) Workaholics Info

4) Home of the Workaholics

5) Workaholics Dreamworks

6) Workaholics Information

7) Workaholics Woes

8) Dale Carnegie Training

9) Workaholics in a Family Business

10) UMHS—Workaholics

FIG. 13 (page 13) is a flowchart of our example ADDICTIONS. This is the possible path that the user takes when making a search.

FIG. 14 (page 14) is the schematic for running the invention offline from the hard drive, floppy, cdrom, or other offline media. From the hard drive, the program has to be downloaded from the internet into the user's hard drive.

FIG. 15 (page 15) is the schematic flowchart of the database access used by this invention, on demand, online.

FIG. 16 (page 16) illustrates the schematic flowchart of the database access for subsequent retrieval of the information from the cache or temporary folder.

FIG. 17 (page 17) is the schematic for running the invention online and offline (combo scheme). If a user has an offline installation of device in user's computer, and logs online by a direct internet connect, the program will adjust itself to first go to the local offline for the database before logging to the internet.

The following is an example of a mouse-over display search menu tree FORMAT lit up and moused over by the user in the following manner:

### Family Tree Menu

A) TRUNK=Antiques & Collectibles

B) BRANCH=Stamps

C) FRUIT=5 Items to choose from . . . James T. McCusker, Inc.,

Lingens.com, Stamp & Coin, etc.

Antique & Collectibles

Antique Furniture

Antique Maps

Coins

Comic Books

Dolls & Figurines

Music Collectibles

Pottery

Sports Collectibles

STAMPS

James T. McCusker, Inc

Unique Collectibles

Lingens.com

Stamp & Coin

Stampview.com

Alfins

PhilatelicConnection

The user has moused-over

A) antiques & collectibles,

B) stamps,

C) and can click any of the items moused-over by stamps . . . James T. McCusker, Inc., etc. and end up in that specific website.

This is a Presearch Engine in which the pre defined database of files, records, and folders have been presearched and categorized for easy access by the user in a single click (clickend).

A) Spectrum of Presearch Engine . . . generational range +P1 Specifically, a presearch engine can be generated in 3 (three) possible mouse movements: +P2 a) Horizontal Access—Mouse Over Display Column Row Spread (MODCROWS) . . . (Row Row Row Your Mouse Genlty Down the Web) +P2 b) Horiventical Access—Mouse Over Display Tree Menu (HORIVENTICAL SEARCH ENGINE) format. A combination vertical and horizontal search en gine combo +P2 c) Vertical Access—Single Click Display Drop Tree Menu (TREE SEARCH EN GINE) B) Platform's Environment +P1 Offline +P1 Invention works with operating systems such as Windows, NT, Novell, etc where data needs to be managed; and also works with the world wide world WWW where offline access can presearch the URL of interest to find desired data +P1 Online +P1 The internet or world wide web (WWW) where data management and manipulation is desired through the use of communication devices and a browser to properly define desired search. Online could also involve intranet, Ian (lacal area network), and other means of online access. C) Framework of the Invention The invention has a framework that takes on the following form or format: +P1 a) Machette.com. . . . the title page name with a “tm” notice on internet +P1 b) Trunk +P1 c) Branch +P1 d) Fruit +P1 e) Bottom Scrollbar underneath serving Branch and Fruit +P1 f) Side Scrollbar to the right of the entire framework +P1 g) Copyright notice comprising of 3 requirements: +P2 copyright logo or notice +P2 year of copyright +P2 copyright assignee/owner +P1 h) “Patent Pending” notice with a “powered by Presearch Engine” notice C) Detailed claims & specifics +P1 MODCROWS . . . A horizontal mouseover display search . . . see CLAIM (A) above. Spectrum of Presearch Engine.

1) Apparatus for searching a pre-defined database of files, records, and folders for a specifically sought after item on the internet or other database using a mouse over display search tree menu of a trunk, branch, and fruit

2) Framework of the apparatus consists of at least three or more distinctive compartments (see FIG. 1, Page 1) . . . Branch can consists of as many subs as desired:
a) Trunk
b) Branch(es)
c) Fruit

3) Trunk compartment is the initial segment of the apparatus and is located to the left of the design. The following elements are present in the trunk compartment:
a) Alphabetical shortcut index scrollbar on top
b) Alphabetical shortcut Index scrollbar at the bottom (Identical to top)
c) Manual trunk scrollbar to right of TRUNK items
top arrow mini scrollbar
middle block scrollbar
bottom arrow mini scrollbar
d) List of items to be searched

4) The mini scroller on the manual trunk scrollbar works in opposite direction. The top mini scroller moves items downwards one at a time while the bottom mini scroller moves items to the top one at a time by clicking on it; in the same respect, the middle block scroller on the same scrollbar works in opposite direction to the listing of trunk items just like the mini scrollers

5) Alphabetical shortcut index scrollbar on top and/or bottom of the trunk lets the user to easily go from one item to another, based on the beginning letter of the item being searched, without the extended delay in scrolling using the manual scrollbar to the right of the trunk. It is a form of automatic scrolling by choosing the beginning letter of the item desired.

6) Alphabetical shortcut index scrollbar at the bottom of the trunk listing is identical to the one on top except that it makes it easy for users who are searching items at the bottom of the screen not to go up the trunk unnecessarily when they could easily click the index at the bottom

7) Manual trunk scrollbar to the right of the trunk lets user go from one item to another without the inconvenience of not finding item that are in the trunk but out of the view of the trunk. This scrollbar consists of a top arrow mini scroller, a middleblock scroller, and a bottom arrow mini scroller. The mini scrollers move listed items on the trunk one at a time. The middle block scroller moves blocks of items at a time depending on the force or depth of the upward or downward movement of the bar.
For example, a user will use a top arrow mini scroller to go from items in letter “G” to items in letter “F” because these letters are neighbors and close. However, to go from letter “D” to “P”, it will be wise for the user to either use the top or bottom index scrollbar for specificity; but, user could also resolve to use middle block scroller in the scrollbar to the right of the trunk

8) At any given time, trunk displays thirty five (35) items within the frame in the viewable portion of the compartment but can vary depending on the “size” of the “type” being used. The larger the type size, the less the number of items to fit in the viewable framework of the trunk and vice versa

9) To the right of the TRUNK is a viewable picture area to display rows, columns, messages, ads, text, graphics, etc. that maybe desired. The displays could be tied to each individual item link in the mouse over display search element or any message so desired such as a background item, billboard, etc.

10) This area takes on a different characteristic when a mouse is placed on a rows of data or groups of related data. This row of data is a distinctive set of trunk item and mouseover display takes over by popping up the columns and related titles that are a sub-division of the trunk item. Particularly, the area is called a BRANCH. An item can have one or more branches depending on the particular item

11) Trunk items in apparatus are arranged in alphabetical order. Items in this frame number thirty five (35) but can be increased or decreased by changing the size of the type style used to compose the item list in the viewable framework

12) Method distinctively identifies main item in this frame as mouse over display search trunk (MODSt) . . . trunk of tree menu. This trunk is readily identifiable by the generic mouse over display search logos (MODSL) that preceed each of the listed items to be searched

13) At the trunk level of framework, apparatus functions as a presearch engine commencement process comprising of a list of items in framework as described in claim 10. User points mouse to any item on list and the item lights up and automatically triggers a pegged Mouse Over Display Search Column (MODSC) of elements in the BRANCH

14) From claim 10 position of a column list of items (elements) that were recently lit up by the user moving the mouse on the first list of column in the BRANCH or BRANCHES, user has option to choose from items in recently triggered column/row by mouse-overring on any of the DETAILED items in this column's row in what is called the FRUIT

15) Apparatus emphasizes the possibility of columns and rows not matching up in straight line left to right (rows) or up and down for (columns) with chosen trunk item that initiated the mouse over display search row/column in the BRANCH. In other words, pointing the mouse on a TRUNK item will not generate BRANCH and FRUIT items that are in a straight line to correspond to the exact pop up. This is possible due to the different versions of video display adapters, browser versions, software compatibility, and other related bugs; however, the content effect is still the same in that only highlighted item in a column/row will trigger the mouse over display search column/row from which to further mouse-over and further choose or choose and click the desired end item

16) Items in column in BRANCH or BRANCHES could be any number in size but are based on the possible number of relevant categories that properly define the respectively distinctive groups that would fit into user's initial mouse over choice item . . . eg “auto” will break down as groups: manufacturers, dealers, collectors, financing, internet aggregators (autobytel), VIN History Check, etc.

17) Apparatus thus triggers rows and columns with items in them for distinctive choices based on desired item that is initially chosen by user from framework list of items in the trunk (MODST). These items in rows and columns have an arrow pointing to the right telling user to “further investigate”

18) Noticeably in BRANCH compartment preceeding branch items, are arrows pointing to the right indicating “further investigate”. This continuance indicator is only in the BRANCH or branches and tells user that more groupings or details are available for further investigation

19) Mouse-overred display search columns and rows items in the TRUNK and BRANCH are typically described in generic classifications in distinctively related groups pegged on the user's first choice of item being searched. As the user further investigates, items become specific by name d addressing

20) Apparatus, of course, has an arrow pointing to the right at the beginning of each item in the sub-column or row indicating that more mouse over display search items are calling to the right. If an arrow does not exist, then the user has reached the end of the search in that category and can click that particular item in that column/row. The item is identified by a distinctive name which is an option choice out of the entire list of items presented to user. Again, these items are in the FRUIT compartment

21) List of clickable items claimed in claim 19 are called clickends and can vary in quantity depending on the subject matter but are limited to a maximum of 50 items at most for fear of “internet overload”

22) Items that are at the end of a mouse over display search tree menu (column/row) are called “clickends” or “a clickend”. And, the act of clicking any of these items is called “to clickmark” as opposed to “to bookmark” which referred to reading books in the golden years of civilization

23) FRUIT items are clickable and are called clickends. Noticeably missing on clickends are the arrows pointing to the right because there are no more items to the right or any direction. This is the end of the tree family menu. Thus, it is a single click process at the clickend. This single click takes the user to the desired website as named or described in plain english

24) claim 21 notes the clickable function of the FRUIT item. Also, fruit items are clickable. Believe it or not, this is the only place that the user has to CLICK THE MOUSE FOR THE FIRST TIME. And, the user only CLICKS ONCE

25) FRUIT items that the user clicks are notorious for being specific by having a unique or specific name and a website address underneath them. In a case where the MODCROWS is not on the web, the clickends lead to another set of files, folders, or addresses

26) As one looks keenly at FRUIT items, one notices that they are numbered to facilitate access and recoil dial-ups. Trunk and Branch can also be numbered as desired

27) The following are typical clickend (FRUIT item) characteristics:
a) they light up with a “hand” meaning user should click. They could also be reversed as cascading mouse moves. They are CLICKABLE
b) they are not preceeded by “right arrows” for “further investigation”
c) they are at the end of the mouse over display search tree menu in clickends (MODCROWS). Cascading ends
d) they are numbered in ascending order
e) they bear a specific name of a person, company, group, agency, entity, etc.
f) they are linked to a website through a URL . . . dot com or network

28) Clickend items vary in quantity depending on the group classification. If the items in the FRUIT are longer than the viewable area, system will trigger a FRUIT SCROLLBAR at the bottom and right of the FRUIT COMPARTMENT for maneuvability

29) Each clickend has a unique URL or dotcom address pegged to it into the World Wide Web or offline database. The URL is a specific web address that is identifiable only to this clickend holder with a tag of .com, .net, .gov, etc. tailoring the specific name which was obtained from a DNS provider

30) Apparatus requires an ISP (an internet service provider) hookup and an internet browser to be present for presearch engine to be operational. Any ISP will do fine irrespective of the connecting speed of the modem or device. Current popular browsers that are recommended (but not limited to) are Netscape and Internet Explorer. Operating system recommended are Windows 95, 98, 2000, NT, XP, etc.

31) Apparatus is programmed such that when a user clickends a desired element in the FRUIT, the request triggers a dial up command that beckons on the ISP (Internet Service Provider) access number for internet hook up on a cold start . . . if the user was not already on the internet. Thus, device will dial up and connect user to user's ISP

32) Apparatus, when downloaded or and installed from other media, will automatically place an icon on the desktop and at the taskbar of the Windows 95/98/2000/ME/XP or Windows 2000 Start Taskbar. This technically means that the program is in the Windows Start Menu or other “ease of access” location

33) Apparatus as claimed in claim 32 (cold start to the internet) may not hold for those users who are already on the internet in a particular website on the internet. For these users, apparatus merely requires that user click at the presearch engine icon and the device will be ready to function . . . linked

34) Apparatus as claimed in claim 32 pops up a screen in a framework format with all the details of the device present and ready to go. This screen has the usual Windows 9X and Windows 2000 minimize, scale, and close functions at the top right hand corner of the framework . . . page as it is attached to the browser frame
minus means place on hold at the taskbar at bottom of desktop
square means minimize screen
“x” means close screen

35) When a user clicks a clickend in the fruit and the website opens up, user can close the web site by clicking the “x” at the top right hand corner, minimize by clicking the square, or put page on hold by clicking the minus and thus still displaying apparatus for further search with previous cells, categories, and items still showing

36) Once user is dialed into a website, user can go back to presearch engine in two ways:
a) go to the back function of the browser and click it
b) just “x” out or put page on taskbar

37) Apparatus initially has a trunk, branch, and fruit. Branch can break down into more branches or subs as desired in levels as mind can allow on way to fruit

38) Apparatus as described above can take varying forms of design to enhance distinctive features in apparatus. The following distinctive features are available and claimed in the invention but more features to enhance the look, format, and ease of apparatus are featured:
a) trunk, branch, and fruit cells can be made transparent (less than 100%) or solid. At “transparency stage” user can read items on the back ground of opened and cascaded cells. At “solid stage” background is not readable.
b) trunk, branch, and fruit items in their respective cells can take on “designer features” as follows:
bullets, highlights, underline, bold, reverse, strike through, italics, blinkers (logon Machette.com and see “Dead Woman Shop ping”), scrollers, greater than or less than symbols, cascade for more, etc.
c) a logo, an icon, and/or other symbol precedes each trunk, branch, or fruit item in its respective cell to proper describe and enhance the search process
d) advertisements, news items, announcements, gaming items, images, etc. are integrated in MODCROWS in the background of the opened cells of the trunk, branch, or fruit. These images can also take the form of pop-up during cascading instead of just rows and columns towards the fruit and clickable goal.

37) Apparatus, at any given time has a specific count of URLs or population search. This means that the user has a definite number of predetermined elements to choose from as opposed to an infinite witch hunt of a search as commonly done today by most search engines. As of filing date, device has 42,683 dotcoms or URLs. Total Presearch=Total of Each Trunk Element (MODStT)=(X)MODSb x (Y)MODSf where X is the number of items in a branch MODB and Y is the number of items (MODSf) linked to that specific branch and so on.
